(19) United States
(12) Patent Application Publication
(10) Pub. No.: US 2021/0147180 A1
(43) Pub. Date: May 20, 2021

(54) ELEVATOR SIGNALIZATION DEVICE WITH ADAPTIBLE VISIBILITY

(71) Applicant: Kone Corporation, Helsinki (FI)

(72) Inventors: Sami SAARELA, Helsinki (FI); Aki HAIKONEN, Helsinki (FI); Sakke AHONIEMI, Helsinki (FI); Klaus MAKELA, Helsinki (FI)

(73) Assignee: Kone Corporation, Helsinki (FI)

(21) Appl. No.: 17/159,682

(22) Filed: Jan. 27, 2021

Related U.S. Application Data
(63) Continuation of application No. PCT/FI2018/050601, filed on Aug. 23, 2018.

(51) Int. Cl. B66B 3/00; B66B 1/46; B66B 1/34

(52) U.S. Cl. CPC B66B 3/002; B66B 1/463; B66B 1/3492; B66B 2201/101; B66B 1/468; B66B 2201/4623; B66B 2201/463; B66B 1/467

(57) ABSTRACT

According to an aspect, there is provided an elevator signalization device. The elevator signalization device comprises a a panel configured to provide information associated with an elevator system to a user, and a processing unit configured to receive at least one trigger signal, and adapt contrast in at least one section of the panel based on the received at least one trigger signal.

### CROSS-REFERENCE TO RELATED APPLICATION

This application is a continuation of PCT International Application No. PCT/FI2018/050601 which has an International filing date of Aug. 23, 2018, the entire contents of which are incorporated herein by reference.

### BACKGROUND

Elevator hall calls, car calls, and other requests from a passenger relating to an elevator are usually provided with a signalization panel. The signalization panel is usually located inside an elevator car or in the vicinity of elevator doors in a hall. Requests are traditionally signaled to an elevator control unit via push buttons located on a panel. Alternatively, more modern version may use virtual buttons provided by a touch-sensitive display. The conventional solutions may cause difficulties for people with poor vision to first detect the car operating panel from the wall and then to detect the correct button from the car operating panel.

### SUMMARY

According to at least some of the aspects, a solution is provided that is able to adapt contrast in elevator signalization devices. In addition, the solution enables creating visually appealing signalization panels while still providing for accessibility requirements.

According to a first aspect, there is provided an elevator signalization device comprising a panel configured to provide information associated with an elevator system to a user; and a processing unit configured to receive at least one trigger signal; and adapt contrast in at least one section of the panel based on the received at least one trigger signal.

In an embodiment, the at least one trigger signal comprises a first trigger signal and a second trigger signal, and the processing unit is configured to adapt contrast in the at least one section of the panel in response to the first trigger signal and a second trigger signal simultaneously.

In an embodiment, additionally or alternatively, the at least one trigger signal comprises a first trigger signal and a second trigger signal, and the processing unit is configured to adapt contrast in the at least one section of the panel in response to the first trigger signal and a second trigger signal consecutively.

In an embodiment, additionally or alternatively, the at least one trigger signal comprises a first trigger signal indicating a passenger approaching the elevator signalization device, and the processing unit is configured to adapt contrast in a first section of the panel in response to the first trigger signal.

In an embodiment, additionally or alternatively, the first section of the panel comprises at least one edge of the panel.

In an embodiment, additionally or alternatively, the at least one trigger signal comprises a second trigger signal indicating close proximity of the passenger to the elevator signalization device, and the processing unit is configured to adapt contrast in a second section of the panel in response to the second trigger signal.

In an embodiment, additionally or alternatively, the at least one trigger signal comprises a second trigger signal indicating close proximity of the passenger to the elevator signalization device, and the processing unit is configured to adapt contrast in a second section of the panel in response to the second trigger signal.

In an embodiment, additionally or alternatively, the second section of the panel comprises at least one signalization button provided by the panel.

In an embodiment, additionally or alternatively, the processing unit is configured to, when an elevator car passes a floor, increase contrast of a signalization button associated with the floor; and, when the floor has been passed, decrease contrast on the signalization button associated with the floor.

In an embodiment, additionally or alternatively, the at least one trigger signal comprises a first trigger signal indicating a deceleration phase of an elevator car and a second trigger signal indicating an elevator car door operating phase, and the processing unit is configured to, when adapting contrast, provide a first color with a section of the panel in response to the first trigger signal; and, when adapting contrast, provide a second color with the section of the panel in response to the second trigger signal.

In an embodiment, additionally or alternatively, the at least one trigger signal comprises a trigger signal indicating an elevator car operating state, and the processing unit is configured to, when adapting contrast, provide a first color with a section of the panel in response to the trigger signal.

In an embodiment, additionally or alternatively, the panel comprises a light-emitting panel, wherein the processing unit is configured to control the light-emitting panel to provide the adapted contrast.

In an embodiment, additionally or alternatively, the panel comprises a touch-sensitive display, wherein processing unit is configured to control the touch-sensitive display to provide the adapted contrast.

In an embodiment, additionally or alternatively, the processing unit is configured to provide the adapted contrast by colors displayed on the touch-sensitive display.

In an embodiment, additionally or alternatively, the elevator signalization device comprises a car operating panel.

In an embodiment, additionally or alternatively, the elevator signalization device comprises a landing signalization device.

According to a second aspect, there is provided an elevator car comprising the elevator car signalization device of the first aspect.

According to a third aspect, there is provided a controller of an elevator system. The controller comprises at least one processing unit; and at least one memory; wherein the at least one memory stores program instructions that, when executed on the at least one processing unit, causes the controller to receive at least one trigger event; and send at least one trigger signal to an elevator signalization device in order to adapt contrast in at least one section of a panel of the elevator signalization device.

In an embodiment, the at least one trigger signal comprises a first trigger signal and a second trigger signal, and the processing unit is configured to adapt contrast in the at least one section of the panel in response to the first trigger signal and a second trigger signal simultaneously.

In an embodiment, additionally or alternatively, the at least one trigger signal comprises a first trigger signal and a second trigger signal, and the processing unit is configured to adapt contrast in the at least one section of the panel in response to the first trigger signal and a second trigger signal consecutively.

In an embodiment, additionally or alternatively, the at least one memory stores program instructions that, when executed on the at least one processing unit, causes the controller to receive a first trigger event from a first sensor, the first trigger event indicating an approaching passenger, and wherein the at least one trigger signal a trigger signal to adapt contrast in a first section of the panel.

In an embodiment, additionally or alternatively, the first section of the panel comprises at least one edge of the panel.

In an embodiment, additionally or alternatively, the at least one memory stores program instructions that, when executed on the at least one processing unit, causes the controller to receive a second trigger event from a second sensor, second trigger signal indicating close proximity of the passenger to the elevator signalization device, and wherein the at least one trigger signal comprises a second trigger signal to adapt contrast in a second section of the panel.

In an embodiment, additionally or alternatively, the second section of the panel comprises at least one signalization button provided by the panel.

In an embodiment, additionally or alternatively, the at least one trigger signal comprises a first trigger signal to increase contrast of a signalization button associated with the floor when an elevator car passes a floor; and a second trigger signal to decrease contrast on the signalization button associated with the floor when the floor has been passed.

In an embodiment, additionally or alternatively, the at least one trigger signal comprises a first trigger signal indicating a deceleration phase of an elevator car to the elevator signalization device to provide a first color with a section of the panel; and a second trigger signal indicating an elevator car door operating phase to the elevator signalization device to provide a second color with the section of the panel.

In an embodiment, additionally or alternatively, the at least one trigger signal comprises a trigger signal indicating an elevator car operating state to provide a first color with a section of the panel.

In an embodiment, additionally or alternatively, the at least one memory stores program instructions that, when executed on the at least one processing unit, causes the controller to control the elevator signalization device to provide the adapted contrast via a light-emitting panel.

In an embodiment, additionally or alternatively, the at least one memory stores program instructions that, when executed on the at least one processing unit, causes the controller to control the elevator signalization device to provide the adapted contrast via a touch-sensitive display.

According to a fifth aspect, there is provided a method for an elevator signalization device. The method comprises receiving at least one trigger signal; and adapting contrast in at least one section of a panel of the elevator signalization device based on the received at least one trigger signal the panel being configured to provide information associated with an elevator system to a user.

According to a fifth aspect, there is provided a method for a controller of an elevator system. The method comprises receiving at least one trigger event; and sending at least one trigger signal to an elevator signalization device in order to adapt contrast in at least one section of a panel of the elevator signalization device.

According to a sixth aspect, there is provided a computer program comprising a program code which, when executed by at least one processing unit, causes the at least one processing unit to perform the method of the third aspect.

According to a seventh aspect, there is provided a computer readable medium comprising a program code which, when executed by at least one processing unit, causes the at least one processing unit to perform the method of the fourth aspect.

According to an eight aspect, there is provided an elevator signalization device comprising means for providing information associated with an elevator system to a user; means for receiving at least one trigger signal; and means for adapting contrast in at least one section of the panel based on the received at least one trigger signal.

According to a ninth aspect, there is provided a controller of an elevator system. The controller comprises means for receiving at least one trigger event; and means for sending at least one trigger signal to an elevator signalization device in order to adapt contrast in at least one section of a panel of the elevator signalization device.

The above discussed means may be implemented, for example, using at least one processor, at least one processor and at least one memory connected to the at least one processor, or at least one processor, at least one memory connected to the at least one processor and an input/output interface connected to the at least one processor.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an elevator signalization device.

FIG. 2A illustrates adapting contrast of an elevator signalization device.

FIG. 2B illustrates adapting contrast of an elevator signalization device.

FIG. 2C illustrates adapting contrast of an elevator signalization device.

FIG. 2D illustrates adapting contrast of an elevator signalization device.

FIG. 2E illustrates adapting contrast of an elevator signalization device.

FIG. 2F illustrates adapting contrast of an elevator signalization device.

FIG. 2G illustrates an exemplary elevator car comprising an elevator signalization device.

FIG. 3A illustrates adapting contrast of an elevator signalization device.

FIG. 3B illustrates adapting contrast of an elevator signalization device.

FIG. 3C illustrates adapting contrast of an elevator signalization device.

FIG. 3D illustrates adapting contrast of an elevator signalization device.

FIG. 3E illustrates adapting contrast of an elevator signalization device.

FIG. 4A illustrates adapting contrast of a destination operating panel.

FIG. 4B illustrates adapting contrast of a destination operating panel.

FIG. 4C illustrates adapting contrast of a destination operating panel.

FIG. 4D illustrates adapting contrast of a destination operating panel.

FIG. 5 illustrates a controller of an elevator system for controlling the elevator signalization device.

FIG. 6 illustrates a flow diagram of a method for an elevator signalization device.

FIG. 7 illustrates a flow diagram of a method for a controller of an elevator system.

### DETAILED DESCRIPTION

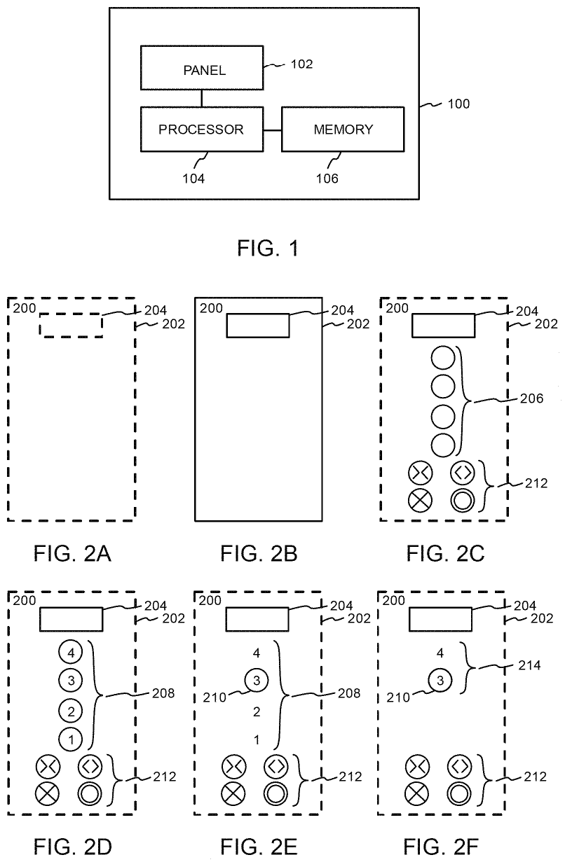

FIG. 1 illustrates an elevator signalization device 100 according to an aspect. The elevator signalization device 100 comprises a panel 102 configured to provide information associated with an elevator system, and a processing unit 104. The processing unit 104 is configured to receive at least one trigger signal, and adapt contrast in at least one section of the panel 102 based on the received at least one trigger signal. The elevator signalization panel 102 may further comprise a memory 106 configured to store program instructions that, when executed by the processing unit 104, causes the processing unit 104 to perform the programmed functionality.

The term “contrast” may refer to the difference in luminance, brightness and/or color that makes a section or sections of the elevator signalization device 100, an element of the elevator signalization device 100 or an area of the elevator signalization device 100 distinguishable. Referring to color contrast, colors that provide high contrast and also provide enough contrast between content and the background may be used. For example, by using black and white, high contrast can be achieved. Contrasting colors may be colors from different segments of a color wheel or “opposite” colors. Luminance contrast may refer to light reflected from one surface or component, compared to light reflected from another surface or component. In other words, luminance contrast may depend on reflective properties of each color and materials.

The term “adapt” in connection with “contrast” may mean that contrast is changed, increased or decreased in at least one section of the elevator signalization device 100. Adapting of the contrast may be made in the at least one section of the elevator signalization device 100 simultaneously (i.e. at the same time) or consecutively (i.e. adapting contract first in a first section and after that in second section, or adapting contrast in a single section consecutively using different types of adaptation).

The phrase “at least one section of the panel 102” may refer to a portion of the panel 102 whose contrast may be independently adapted, for example, an edge of the panel, an edge of a signalization button of the panel, a symbol of a signalization button or the complete face of the panel 102.

For example, the processing unit 106 may be configured to adapt contrast on the whole panel 102 when an elevator has limited service or it is out of order. The panel 102 of the elevator signalization device 100 may be, for example, fully yellow when the elevator is operating at limited speed or when some of the landings are unavailable. As another example, the elevator signalization device 100 may be fully red when the elevator is out of service.

In another example, the processing unit 104 may be configured to increase contrast first on edges of at least one signalization button, and then subsequently increase contrast on symbols of the at least one signalization button. In another embodiment, the processing unit 104 may be configured to increase contrast on the edges and symbols of the at least one signalization button simultaneously. In another embodiment, the processing unit 104 may be configured to increase contrast only on symbols, when increasing contrast of the at least one signalization button.

In an embodiment, the processing unit 104 may be configured to sense an interaction with at least one signalization button, and decrease contrast at least on edges of signalization buttons other than the interacted signalization button.

In an embodiment, the processing unit 104 may be also configured to provide increased contrast on at least one predetermined signalization button constantly. For example, alarm and emergency stop buttons may constantly have increased contrast.

Further, the processing unit 104 may be configured to decrease contrast of a signalization button when the function provided by the signalization button is not available. For example, if the panel is a car operating panel in an elevator car, at each time instant, the panel may provide increased contrast only on signalization buttons that can be selected.

In an embodiment, the elevator signalization device 100 may comprise a light-emitting panel, and the processing unit 104 may be configured to control the light-emitting panel to provide the adapted contrast. The adapted contrast may be provided by changing colors and/or light intensity of the light produced by the light-emitting panel.

In an embodiment, the panel 102 may comprise a touch-sensitive display. The processing unit 104 may be configured to provide the adapted contrast by changing colors and/or light intensity displayed on the touch-sensitive display.

In an embodiment, the processing unit 104 may be configured to provide adapted, increased or decreased contrast by changing color on the at least one edge of the panel, at least one signalization button, or on the whole panel when doors of the elevator are about to open or close.

In an embodiment, the processing unit 104 may be configured to adapt contrast by changing color on the at least one edge of the panel, at least one signalization button, or on the whole panel when the elevator is about to accelerate or decelerate. Thus, passengers may be able to prepare for the changes of movement of the elevator car. The provided information may help, for example, the elderly and groups with special needs in maintaining balance.

In an embodiment, the elevator signalization device, for example, a car operating panel may have both physical signalization buttons and signalization buttons provided by a touch-sensitive display. For example, signalization buttons providing safety functions, such as an alarm button, may be a physical button, and the remaining signalization buttons, such as floor buttons, may be provided by the touch-sensitive display.

In an embodiment, the elevator signalization device 100 may be a car operating panel located inside an elevator car. In another embodiment, the elevator signalization device 100 may be a landing signalization device, such as a destination operating panel or a landing call panel.

Further, in an embodiment, at least one of the panel 102, processor 104, and the memory 106 may constitute means for receiving at least one trigger signal and means for adapting contrast in at least one section of the panel 102 based on the received at least one trigger signal.

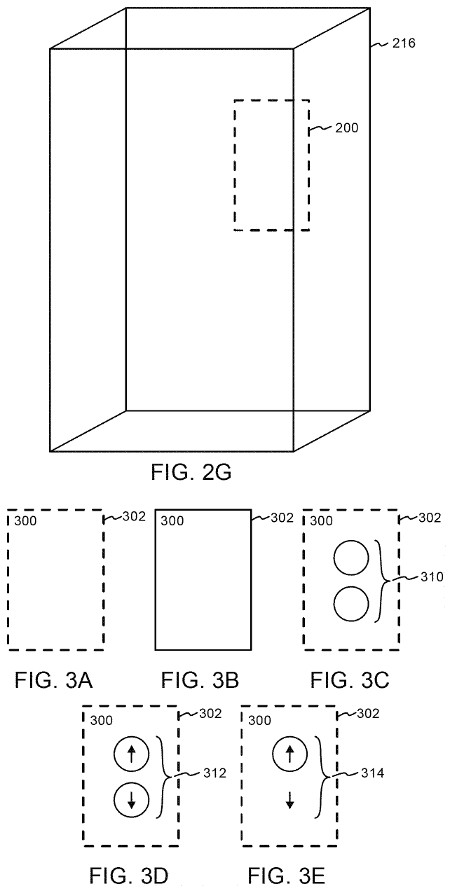

FIGS. 2A-2E illustrate examples of adapting contrast of an elevator signalization device. The elevator signalization device illustrated in FIGS. 2A-2E may be a car operating panel inside an elevator car. FIGS. 2A-2E illustrate a simplified example, and the car operating panel may refer to a full height or a partial height car operating panel, a vertical type car operating panel or to a horizontal type car operating panel.

FIG. 2A illustrates a situation when the elevator car comprising the elevator signalization device is not moving between floors. A panel 200 of the elevator signalization device and signalization buttons 208, 212 provided by the panel 200 may first be indistinguishable from a wall of the elevator car, for example, fully flat and of the same color as the wall of the elevator car. Further, edges 202 of the panel 200 and edges 206 of the signalization buttons 208 may first have no contrast, or they may have low contrast compared to the surrounding elements of the elevator signalization device. Thus, they may blend completely or almost completely into the surroundings (i.e. the wall of the elevator car) and appear “invisible”. In FIG. 2A, the edges 202 of the panel 200 are represented with a dashed line for illustrative purposes, and the edges 202 may not be distinguishable from the elevator car's wall.

In FIG. 2B, contrast may be adapted, for example, increased on at least one edge of the panel 200. For example, if the front panel of the elevator signalization device is white, the edges 202 of the panel 200 may turn black, as illustrated in FIG. 2B with a solid line. In another embodiment, contrast may be adapted only on some of the edges 202, for example, the left and right edges, or top and bottom edges. The adapted contrast may be provided after receiving a first trigger signal. The first trigger signal may be received, for example, in response to opening of the elevator car doors, detected, for example, by a door sensor. Optionally, the first trigger signal may be received in response to detecting an approaching passenger, for example, by a motion detector or a camera. The first trigger signal indicating an approaching passenger may be also based on user identification, for example, a short-range transceiver identifying a passenger carrying a radio frequency identifier (RFID) tag or a wireless communication device. The adapted or increased contrast on the edges 202 of panel 200 may help the passenger to perceive the panel 200, thus revealing the location of the elevator signalization device to the passenger. A section 204 of the panel 200 illustrates an indicator that displays the current floor of the elevator car. Although illustrated in FIGS. 2B-2F, this section may or may not be present in the panel 200.

In FIGS. 2C and 2D, contrast may be decreased on the at least one edge of the panel 200 and increased on at least one signalization buttons 206, 212 provided by the panel 200. The elevator signalization device may have received a second trigger signal indicating that the passenger is now approaching or has arrived in the vicinity or close proximity of the elevator signalization device. The approaching passenger may have been detected, for example, with a light curtain of the elevator doors, or with a separate sensor inside the elevator car. Optionally, the second trigger signal may be received in response to detecting an approaching passenger, for example, by a motion detector or a camera. The second trigger signal indicating an approaching passenger may be also based on user identification, for example, a short-range transceiver identifying a passenger carrying an RFID tag or a wireless communication device. Further, in another embodiment, the second trigger signal may be a timer expiry signal received from a timer started when the first trigger signal was received.

As the passenger already knows the location of the signalization device due to the adapted contrast as illustrated in FIG. 2B, the indication of the panel location may no longer be needed and the contrast on the edges of the panel 200 may be decreased. Since knowing the location of the signalization buttons 206, 212 is necessary for the passenger, contrast of the signalization buttons 202 may be increased in order to reveal them. The increased contrast on the signalization buttons 202 may be provided simultaneously or sequentially, meaning that the contrast may be first provided only on the edges of the signalization buttons 206, as illustrated in FIG. 2C, and thereafter also on the symbols of the signalization buttons 206, as shown in FIG. 2D. In another example, contrast on the edges 202 of the panel 200 may remain in the increased state simultaneously with increased contrast state of the signalization buttons 206, 212.

In FIG. 2E, an interaction has been sensed with a signalization button 210. In response to the interaction, contrast may be decreased at least on the edges 206 of signalization buttons 208 other than the interacted signalization button 210. For example, the passenger may have selected his destination floor by selecting a physical or tapping a virtual signalization button 210 provided by a touch-sensitive display. The contrast on the selected button may remain unchanged, and the contrast of all the other signalization buttons may be decreased. As illustrated in FIG. 2E, the contrast on the other buttons 208 other than the button 210 may be decreased only on the edges of the buttons, and therefore the passenger is able to identify the non-selected buttons by their symbols enabling making a new selection later.

FIG. 2F illustrates a situation in which the elevator car is already moving. Floor numbers 1 and 2 are not visible/selectable any more as the elevator car has already passed these floors. The floor 3 is still indicated as a selected floor by providing contrast both on the edge and the symbol of the signalization button 210. However, for the floor 4 contrast may be provided only on the symbol, indicating that this floor can still be selected.

In an embodiment, contrast on all of the non-selected signalization buttons 208 may be decreased on the edges 206 as well as on the symbols of the buttons while the selected buttons 210 have an increased contrast. When the elevator car is moving, contrast on a signalization button 208 may be increased when the elevator car passes the floor associated with the signalization button 208. When the floor associated with the signalization button 208 has been passed, contrast of the signalization button 208 may be decreased again.

In an embodiment, at least one predetermined signalization button 212 inside the elevator car, such as an alarm button, a door opening button and/or a door closing button, may have increased contrast constantly. Alternatively, the increased contrast on the at least one predetermined signalization button may be provided only when the elevator car is moving. Also, in another example, signalization buttons which are not available for a passenger, may be kept hidden. For example, if one or more of the floors of the building are closed or locked only for a specific group of people, floor call buttons of these floor will not be provided with increased contrast.

In an embodiment, “opposite colors”, for example, black and white, or colors providing a high contrast difference may be used. In other words, a first color and a second color may alternate when adapted contrast is provided. For example, the panel of the elevator signalization device may first use the first color. Then, after that edges of a signalization button may be provided with the second color while the remaining part of the signalization button may be provided with the first color. After that the symbol of the signalization button may be provided with the first color.

In another embodiment, a single color, for example, white color, may be used as a primary contrasting color. This means that in the sequence of adapting contrast white is always used as the contrasting color while the previous sequence always changes back to black. As an example, the panel of the elevator signalization device may first be black. Then, edges 202 of the panel 200 may be provided with white. Then, edges of a signalization button may be provided with white while the edges of the panel 200 change back to black. After that the symbol of the signalization button may be provided with white while the edges of the signalization button changes back to black.

In an embodiment, there may be provided an arrow with increased contrast during landings, for example, in the indicator section 204, indicating the right direction towards the elevator doors that will open, for example, in elevators cars having doors on opposite sides of the elevator car. Contrast on the arrow may be increased and decreased alternately during the stop in order to create a blinking effect. In another example, an arrow with increased contrast may be provided when the elevator is moving, for example, in the indicator section 204, to indicate the up and down directions of movement of the elevator car.

FIG. 2G illustrates an exemplary elevator car 216 comprising an elevator signalization device illustrated in FIGS. 2A-2F.

FIGS. 3A-3E illustrate adapting contrast of an elevator signalization device. The elevator signalization device illustrated in FIGS. 3A-3E may be a hall call device, and it may be a standalone device or installed in a wall of a landing floor.

FIG. 3A may relate to a situation where an elevator hall is empty. A panel 300 and signalization buttons 312 of the panel 300 may be fully flat and of the same color as the wall of the hall. Further, edges 302 of the panel 300 and the signalization buttons 312 may have no contrast, or they may have low contrast compared to the surrounding elements. This means that the panel 300 and the signalization buttons 312 may not be distinguishable from the wall when there are no passengers present at the hall. Thus, the panel 300 and the signalization buttons may blend completely or almost completely into the surroundings (i.e. the wall) and appear “invisible”. In FIG. 3A, the edges 302 of the panel 300 are represented with a dashed line for illustrative purposes, and the edges 302 may not be distinctive from the elevator hall's wall.

In FIG. 3B, contrast may be adapted on at least one edge 302 of the panel 300. As an example, if the panel 300 is white, the edges 302 of the panel 300 may turn to black, as illustrated in FIG. 3B with a solid line. In another example, contrast may be adapted or increased on some of the edges 302 only, for example, the left and right edges, or top and bottom edges. The adapted or increased contrast may be provided instantly, gradually increasing, or by a light effect, such as a circulating light around the edges 302 of the panel 300 or with a flashing effect.

The adapted or increased contrast may be provided after receiving a first trigger signal. The first trigger signal may be received, for example, in response to an approaching passenger detected with a first sensor. The first sensor may be, for example, a motion detector or a camera. The first trigger event indicating an approaching passenger may be also based on user identification, for example, a short-range transceiver identifying a passenger carrying an RFID tag or a wireless communication device. Further, the first sensor may be integrated into the elevator signalization device, or there may be a wired or wireless connection to the first sensor. Alternatively, the first trigger signal may originate from an elevator controller. The adapted or increased contrast on the edges 302 of panel 300 helps the passenger to perceive the panel 300, thus revealing the location of the elevator signalization device to the passenger.

In FIGS. 3C and 3D, contrast may be decreased on the at least one edge 302 of the panel 300 and increased on the signalization buttons 310 provided by the panel 300. The elevator signalization device may have received a second trigger signal indicating that the passenger has arrived in the vicinity of the elevator signalization device. The approaching passenger may have been detected with a second sensor that may scan the immediate vicinity of the elevator signalization device 100. The second sensor may be, for example, a motion detector or a camera. The second trigger signal indicating an approaching passenger may also be based on user identification, for example, a short-range transceiver identifying a passenger carrying an RFID tag or a wireless communication device. Further, the second trigger signal may also be a timer expiry signal received from a timer started when the first trigger signal was received. Alternatively, the second trigger signal may originate from the elevator controller. As the passenger already knows the location of the signalization device, indication of the location is no longer needed and the contrast on the edges 302 of the panel 300 may be decreased. Since knowing the location of the signalization buttons 312 is necessary for the passenger, the contrast of the signalization buttons 312 may be adapted or increased in order to reveal them. The adapted or increased contrast on the signalization buttons 312 may be provided simultaneously or sequentially, meaning that the contrast may be first provided only on the edges of the signalization buttons, as illustrated by the reference 310 in FIG. 3C, and thereafter also on the symbols of the signalization buttons, as illustrated by the reference 312 in FIG. 3D. In another example, contrast on the edges 302 of the panel 300 may remain in the increased state simultaneously with increased contrast state of the signalization buttons 310, 312.

FIG. 3E illustrates a situation when a passenger has selected the up button. In the signalization buttons 314, contrast is provided in the up button both on the edge and the symbol. In the non-selected down button, contrast is provided only on the symbol.

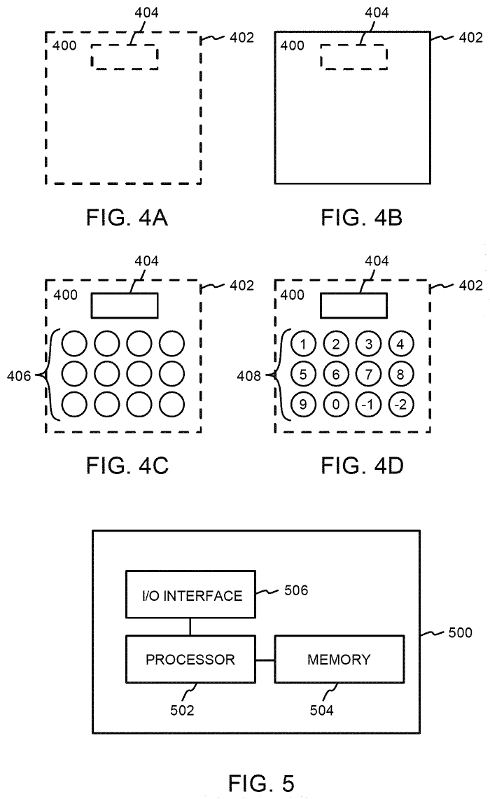

FIGS. 4A-4D illustrate adapting contrast of a destination operating panel 400 according to an aspect.

FIG. 4A may relate to a situation where an elevator hall is empty. Further, edges 402 of the panel 400 and signalization buttons 408 may have no contrast or lower contrast at this point. If a destination operating panel 400 is installed in a wall, the panel 400 may blend into the surroundings and appear “invisible”. In FIG. 4A, the edges 402 of the panel 400 are represented with a dashed line for illustrative purposes, and the edges of the panel 400 may not be distinctive from the elevator hall's wall.

In FIG. 4B, contrast is adapted or increased on at least one edge 402 of the panel 400. Contrast may be adapted or increased on all sides of the panel, or alternatively, contrast may be adapted or increased only on some of the edges 402, for example, the left and right edges, or top and bottom edges. For example, if the panel 400 is white, the edges 402 of the panel 400 may turn to black, as illustrated in FIG. 4B with a solid line. The adapted or increased contrast may be provided instantly, gradually increasing, or by a light effect, such as a circulating light around the edges 402 or a flashing effect.

The adapted or increased contrast may be provided after receiving a first trigger signal. The first trigger signal may be received in response to an approaching passenger detected with a first sensor. The first sensor may be, for example, a motion detector or a camera. The first trigger event indicating an approaching passenger may be also based on user identification, for example, a short-range transceiver identifying a passenger carrying an RFID tag or a wireless communication device. Further, the first sensor may be integrated into the destination operating panel 400, or there may be a wired or wireless connection to the first sensor. Alternatively, the first trigger signal may originate from an elevator controller. The adapted or increased contrast on the edges 402 of panel 400 helps the passenger to perceive the panel 400, thus more clearly revealing the location of the destination operating panel 400 to the passenger.

In FIGS. 4C and 4D, contrast may be decreased on the at least one edge 402 of the panel 400 and increased on the signalization buttons 406, 408 provided by the panel 400. In another example, contrast may remain in the increased state on the edge 402 even if contrast is increased on the signalization buttons 406, 408. The destination operating panel 400 may have received a second trigger signal indicating that the passenger has arrived in the vicinity of the destination operating panel 400. The approaching passenger may have been detected with a second sensor that may scan the immediate vicinity of the destination operating panel 400. The second sensor may be, for example, a motion detector or a camera. The second trigger signal indicating an approaching passenger may be also based on user identification, for example, a short-range transceiver identifying a passenger carrying an RFID-tag or a wireless communication device. Further, the second trigger signal may also be a timer expiry signal received from a timer started when the first trigger signal was received. Alternatively, the second trigger signal may originate from an elevator controller. As the passenger already knows the location of the destination operating panel 400, indication of the location is no longer needed and the contrast on the edges 402 of the panel 400 may be decreased. Since knowing the location of the signalization buttons 406, 408 is necessary for the passenger, the contrast of the signalization buttons 406, 408 may be increased in order to reveal them. The increased contrast on the signalization buttons 406, 408 may be provided simultaneously or sequentially, meaning that the contrast may be first provided only on the edges of the signalization buttons, as illustrated by the reference 406 in FIG. 4C, and thereafter also on the symbols of the signalization buttons, as illustrated by the reference 408 in FIG. 4D.

A section 404 of the panel 400 illustrates an indicator that displays a floor selection and/or the selected number of passengers. The section 404 may first be invisible or provided with no contrast or low contrast, and when increasing contrast on the signalization buttons 406, 408, contrast of the section 404 may also be increased. In an embodiment, the section 404 may comprise an arrow, and contrast on the arrow may be increased when the elevator is moving to indicate the up or down direction of movement of the elevator car.

Thus, only information which is useful for the passenger at each moment is presented for the passenger. The solution enables meeting the accessibility requirements of different levels by adapting the contrast for signalization as required.

FIG. 5 illustrates a block diagram of a controller 500 of an elevator system according to an aspect. The controller 500 comprises at least one processor 502 connected to at least one memory 504 and in input/output interface 506 connected to the at least one processor 506. The at least one memory 504 may comprise program instructions that, when executed by the at least one processor 502, causes the controller 500 to receive at least one trigger event; and send at least one trigger signal to an elevator signalization device in order to adapt contrast in at least one section of a panel of the elevator signalization device. The at least one section of the panel may comprise, for example, the complete panel, at least one edge of the panel or a specific sub-section of the panel.

In an embodiment, the at least one memory 504 stores program instructions that, when executed on the at least one processing unit 502, causes the controller 500 to receive the first trigger event from a first sensor, the first trigger event indicating an approaching passenger. In this case, the at least one trigger signal comprises a trigger signal to adapt contrast in a first section of the panel. The first sensor may be, for example, a motion detector or a camera. The first trigger event indicates an approaching passenger may be also based on user identification, for example, a short-range transceiver identifying a passenger carrying an RFID tag or a wireless communication device. Optionally, the controller 500 may be configured to receive the first trigger event from a door sensor, the first trigger event indicating elevator car doors opening. The first section may comprise, for example, an edge of the panel.

In an embodiment, the at least one memory 504 stores program instructions that, when executed on the at least one processing unit 502, causes the controller 500 to receive a trigger event from at least one of a sensor inside an elevator car or a door sensor, the trigger event indicating an approaching passenger. In this case, the at least one trigger signal comprises a second trigger signal to adapt contrast in a second section of the panel. Optionally, the controller 500 may be configured to receive the second trigger event from a second sensor, the second trigger event indicating a passenger in the vicinity or close proximity of the elevator signalization device 100. The second sensor may be, for example, a motion detector or a camera. The second trigger event indicating an approaching passenger may be also based on user identification, for example, a short-range transceiver identifying a passenger carrying an RFID tag or a wireless communication device. Further, the at least one memory 504 may store program instructions that, when executed on the at least one processing unit 502, causes the controller 500 to receive the second trigger event from a timer, the timer expiring after a predetermined time starting from the first trigger event. The second section may comprise, for example, a signalization button of the panel.

The second trigger signal may be configured to control the elevator signalization device to increase contrast on edges of the at least one signalization button, and increase contrast on symbols of the at least one signalization button. Further, the second trigger signal may be configured to control the elevator signalization device to increase contrast only on symbols of the at least one signalization button.

In an embodiment, the at least one memory 504 may store program instructions that, when executed on the at least one processing unit 502, causes the controller 500 to receive information about an interaction with at least one signalization button, and control the elevator signalization device to decrease contrast at least on edges of signalization buttons other than the interacted signalization button.

Further, the at least one memory 504 may store program instructions that, when executed on the at least one processing unit 502, causes the controller 500 to control the elevator signalization device to decrease contrast of a signalization button when the function provided by the signalization button is not available.

Additionally, the at least one memory 504 may store program instructions that, when executed on the at least one processing unit 502, causes the controller 500 to control the elevator signalization device to provide increased contrast on at least one predetermined signalization button constantly.

In an embodiment, the at least one memory 504 may store program instructions that, when executed on the at least one processing unit 502, causes the controller 500 to control the elevator signalization device to provide the increased or decreased contrast by changing colors displayed on a touch-sensitive display.

In an embodiment, the at least one memory 504 may store program instructions that, when executed on the at least one processing unit 502, causes the controller 500 to control the elevator signalization device to provide the adapted, increased or decreased contrast by changing colors on at least one edge of the panel, at least one signalization button, or on the whole panel when the elevator has limited service or it is out of order.

In an embodiment, the at least one memory 504 may store program instructions that, when executed on the at least one processing unit 502, causes the controller 500 to control the elevator signalization device to provide the adapted, increased or decreased contrast by changing colors on the at least one edge of the panel, at least one signalization button, or on the whole panel when doors of the elevator are about to open or close.

In an embodiment, the at least one memory 504 may store program instructions that, when executed on the at least one processing unit 502, causes the controller 500 to control the elevator signalization device to provide the adapted, increased or decreased contrast by changing colors on the at least one edge of the panel, at least one signalization button, or on the whole panel when the elevator is about to accelerate or decelerate.

In an embodiment, the at least one memory 504 store program instructions that, when executed on the at least one processing unit 502, causes the controller 500 to receive the second trigger event from a timer, the timer expiring after a predetermined time starting from the first trigger event.

The controller 500 may be a control entity configured to implement only the above disclosed operating features, or it may be part of a larger elevator control entity, for example, an elevator controller or an elevator group controller. Thus, FIG. 5 illustrates a solution in which the controlling entity controlling the elevator signalization device may be arranged as a separate entity from the elevator signalization device.

Further, in an embodiment, at least one of the processor 502 and the memory 502 may constitute means for receiving at least one trigger event; and means for sending at least one trigger signal to an elevator signalization device in order to adapt contrast in at least one section of a panel of the elevator signalization device.

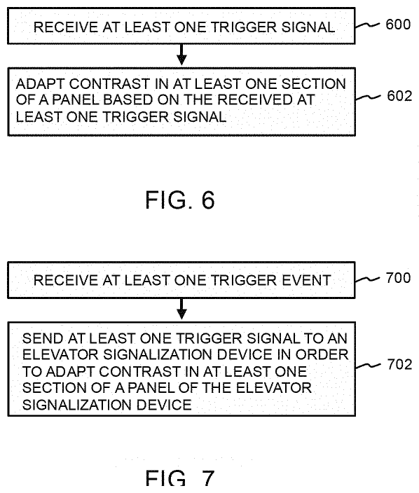

FIG. 6 illustrates a flow diagram of a method for an elevator signalization device according to an aspect.

At 600, at least one trigger signal is received. A trigger signal may indicate, for example, a passenger approaching an elevator signalization device located in an elevator hall, elevator car doors opening, a deceleration or an acceleration phase of the elevator car or an operating state of the elevator car. Various examples and alternatives for the meaning of the at least one trigger signal have been discussed in the examples illustrated in FIGS. 1-5.

At 602, contrast in at least one section of the panel may be adapted based on the received at least one trigger signal. The at least one section of the panel may comprise, for example, the complete panel, at least one edge of the panel or a specific sub-section of the panel. Various examples and alternatives for the at least one section of the panel have been discussed in the examples illustrated in FIGS. 1-5.

FIG. 7 illustrates a flow diagram of a method for a controller of an elevator system.

At 700, at least one trigger event is received. The at least one trigger event may comprise a trigger event received, for example, from a sensor indicating an approaching passenger, from a door sensor indicating elevator car doors opening or from other means for identifying a passenger. The at least one trigger event may also be associated with an operating state of an elevator system or an elevator car.

At 702, at least one trigger signal may be sent to the elevator signalization device in order to adapt contrast in at least one section of a panel of the elevator signalization device. The at least one section of the panel may comprise, for example, the complete panel, at least one edge of the panel or a specific sub-section of the panel. Various examples and alternatives for the at least one section of the panel have been discussed in the examples illustrated in FIGS. 1-5.

The exemplary embodiments and aspects of the invention can be included within any suitable device, for example, including, servers, workstations, capable of performing the processes of the exemplary embodiments. The exemplary embodiments may also store information relating to various processes described herein.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator signalization device comprising:
a panel configured to provide information associated with an elevator system to a user;
a processing unit configured to:
receive at least one trigger signal; and
adapt contrast in at least one section of the panel based on the received at least one trigger signal.

2. The elevator signalization device of claim 1, wherein the at least one trigger signal comprises a first trigger signal and a second trigger signal, and the processing unit is configured to adapt contrast in the at least one section of the panel in response to the first trigger signal and a second trigger signal simultaneously.

3. The elevator signalization device of claim 1, wherein the at least one trigger signal comprises a first trigger signal and a second trigger signal, and the processing unit is configured to adapt contrast in the at least one section of the panel in response to the first trigger signal and a second trigger signal consecutively.

4. The elevator signalization device of claim 1, wherein the at least one trigger signal comprises a first trigger signal indicating a passenger approaching the elevator signalization device, and the processing unit is configured to:
adapt contrast in a first section of the panel in response to the first trigger signal.

5. The elevator signalization device of claim 4, wherein the first section of the panel comprises at least one edge of the panel.

6. The elevator signalization device of claim 4, wherein the at least one trigger signal comprises a second trigger signal indicating close proximity of the passenger to the elevator signalization device, and the processing unit is configured to:
adapt contrast in a second section of the panel in response to the second trigger signal.

7. The elevator signalization device of claim 6, wherein the second section of the panel comprises at least one signalization button provided by the panel.

8. The elevator signalization device of claim 1, wherein the processing unit is configured to:
when an elevator car passes a floor, increase contrast of a signalization button associated with the floor; and
when the floor has been passed, decrease contrast on the signalization button associated with the floor.

9. The elevator signalization device of claim 1, wherein the at least one trigger signal comprises a first trigger signal indicating a deceleration phase of an elevator car and a second trigger signal indicating an elevator car door operating phase, and the processing unit is configured to:
when adapting contrast, provide a first color with a section of the panel in response to the first trigger signal; and
when adapting contrast, provide a second color with the section of the panel in response to the second trigger signal.

10. The elevator signalization device of claim 1, wherein the at least one trigger signal comprises a trigger signal indicating an elevator car operating state, and the processing unit is configured to:
when adapting contrast, provide a first color with a section of the panel in response to the trigger signal.

11. The elevator signalization device of claim 1, wherein the panel comprises a light-emitting panel, wherein the processing unit is configured to control the light-emitting panel to provide the adapted contrast.

12. The elevator signalization device of claim 1, wherein the panel comprises a touch-sensitive display, wherein processing unit is configured to control the touch-sensitive display to provide the adapted contrast.

13. The elevator signalization device of claim 12, wherein the processing unit is configured to provide the adapted contrast by colors displayed on the touch-sensitive display.

14. The elevator signalization device of claim 1, wherein the elevator signalization device comprises a car operating panel.

15. The elevator signalization device of claim 1, wherein the elevator signalization device comprises a landing signalization device.

16. An elevator car comprising the elevator signalization device of claim 1.

17. A controller of an elevator system, the controller comprising:
at least one processing unit; and
at least one memory;
wherein the at least one memory stores program instructions that, when executed on the at least one processing unit, causes the controller to:
receive at least one trigger event; and
send at least one trigger signal to an elevator signalization device in order to adapt contrast in at least one section of a panel of the elevator signalization device.

18. The controller of claim 17, wherein the at least one trigger signal comprises a first trigger signal and a second trigger signal, and the processing unit is configured to adapt contrast in the at least one section of the panel in response to the first trigger signal and a second trigger signal simultaneously.

19. The controller of claim 18, wherein the at least one trigger signal comprises a first trigger signal and a second trigger signal, and the processing unit is configured to adapt contrast in the at least one section of the panel in response to the first trigger signal and a second trigger signal consecutively.

20. The controller of claim 17, wherein the at least one memory stores program instructions that, when executed on the at least one processing unit, causes the controller to receive a first trigger event from a first sensor, the first trigger event indicating an approaching passenger, wherein the at least one trigger signal comprises a trigger signal to adapt contrast in a first section of the panel.

21. The controller of claim 20, wherein the first section of the panel comprises at least one edge of the panel.

22. The controller of claim 20, wherein the at least one memory stores program instructions that, when executed on the at least one processing unit, causes the controller to receive a second trigger event from a second sensor, second trigger signal indicating close proximity of the passenger to the elevator signalization device, wherein the at least one trigger signal comprises a second trigger signal to adapt contrast in a second section of the panel.

23. The controller of claim 22, wherein the second section of the panel comprises at least one signalization button provided by the panel.

24. The controller of claim 17, wherein the at least one trigger signal comprises:
a first trigger signal to increase contrast of a signalization button associated with the floor when an elevator car passes a floor; and
a second trigger signal to decrease contrast on the signalization button associated with the floor when the floor has been passed.

25. The controller of claim 17, wherein the at least one trigger signal comprises:
a first trigger signal indicating a deceleration phase of an elevator car to the elevator signalization device to provide a first color with a section of the panel; and
a second trigger signal indicating an elevator car door operating phase to the elevator signalization device to provide a second color with the section of the panel.

26. The controller of claim 17, wherein the at least one trigger signal comprises a trigger signal indicating an elevator car operating state to provide a first color with a section of the panel.

27. The controller of claim 17, wherein the at least one memory stores program instructions that, when executed on the at least one processing unit, causes the controller to control the elevator signalization device to provide the adapted contrast via a light-emitting panel.

28. The controller of claim 17, wherein the at least one memory stores program instructions that, when executed on the at least one processing unit, causes the controller to control the elevator signalization device to provide the adapted contrast via a touch-sensitive display.

29. A method for an elevator signalization device, the method comprising:
receiving at least one trigger signal; and
adapting contrast in at least one section of a panel of the elevator signalization device based on the received at least one trigger signal, the panel being configured to provide information associated with an elevator system to a user.

30. A method for a controller of an elevator system, the method comprising:
receiving at least one trigger event; and
sending at least one trigger signal to an elevator signalization device in order to adapt contrast in at least one section of a panel of the elevator signalization device.

31. A computer program comprising program code which, when executed by at least one processing unit, causes the at least one processing unit to perform the method of claim 29.

32. A computer readable medium comprising a computer program comprising program code which, when executed by at least one processing unit, causes the at least one processing unit to perform the method of claim 29.
